(19) United States
(12) Patent Application Publication
(10) Pub. No.: US 2002/0039292 A1
(43) Pub. Date: Apr. 4, 2002

(54) Backlight illuminator

(76) Inventor: Hirokazu Matsui, Shiga-ken (JP)

Correspondence Address: REED SMITH HAZEL & THOMAS, 3110 Fairview Park Drive. Suite 1400, McLean, VA, 22042, US

(21) Appl. No.: 09/961,109

(22) Filed: Sep. 24, 2001

(30) Foreign Application Priority Data
Sep. 29, 2000 (JP) 2000-299275

(51) Int. Cl. F21V 7/09

(52) U.S. Cl. 362/297; 362/348

(57) ABSTRACT

A backlight illuminator for liquid crystal displays which is capable of illuminating an illumination surface of the illuminator with uniform high brightness. The illuminator includes a plurality of light sources arranged at a predetermined interval, an illumination surface to be irradiated by both direct and reflected lights of the light sources, and a reflector arranged behind the rear surface of the light source. The reflector includes a slanted reflective surface spread from both sides of each light source having bumps at the uppermost ends of the slanted reflective surface. The illumination surface is irradiated by the reflected light from the slanted reflective surface and a concave or convex bump surface so that the illumination surface may be uniform brightness.

### BACKGROUND OF THE INVENTION

The present invention relates to an illuminator. More particularly, the present invention relates to a backlight illuminator which is suitable for use in various applications, such as, for example, a backlight of liquid crystal displays.

Applicant proposed a backlight illuminator in the co-pending Japanese Patent Application No. Hei 2000-113423.

The backlight illuminator in the co-pending application includes plural light sources (linear light sources) and reflectors. The plural light sources are arranged in front of an illumination surface in parallel and at predetermined intervals in such a manner that each light source illuminates allocated adjacent predetermined illumination areas of the illumination surface and each reflector is disposed behind each light source to reflect an illumination light at the rear surface back to the illumination surface. In addition, each reflector has facetted reflective surfaces spread to disperse the reflected light to allocated illumination areas on both sides of the light source.

The facetted reflective surface disposed on both sides of the light source has a distant-projection reflective surface and a near-projection reflective surface. The distant-projection reflective surface reflects an illumination light back to the illumination surface in the direction where illumination light leaves from the light source. The near-projection reflective surface reflects an illumination light back to the illumination surface in the direction where the illumination light approaches the light source, while the illumination area corresponding to the near-projection reflective surface is overlapped with an illumination region corresponding to the distant-projection reflective surface. An optical reflective material which suppresses a decrease of the optical directivity, such as, a foamed surface, coarse surface or painted surface, to provide an optical diffusivility is used for the distant-projection reflective surface and the near-projection reflective surface.

According to the backlight illuminator in the co-pending Japanese application filed by the applicant, the distant-projection reflective surface and the near-projection reflective surface includes a facetted reflective surface formed of a reflective material with an optical diffusivility. This is advantageous in that the backlight illuminator can be thinned similar to a conventional structure using a high reflective mirror surface formed by vapor-evaporating a high pure aluminum. In addition, a lamp image projected onto the illumination surface and the colored-eye (corresponding to rainbow color) appearing on the mirror surface can be eliminated. Furthermore, a problem on brightness on the illumination surface resulting from the use of the optical reflective material, for example, the non-uniformity of brightness ranging from 10% to 30%, can be eliminated.

The backlight illuminator disclosed in the applicant's co-pending Japanese application enables to realize a high and uniform brightness. For example, the illuminator can be satisfactorily used to an application requiring the uniform brightness, such as a backlighting of liquid crystal displays for wall-mounting television sets.

When the backlight illuminator is mounted on a device, such as, for example, as a backlighting for the liquid crystal display, it is required to reduce the internal space ratio in order to make the size of the illuminator thereof as thin as possible. However, thinning the thickness of the illuminator results in disposing the light sources close to the illumination surface. Thus, it is required that the facetted reflective surface effectively distributes and compensates reflected lights over the illumination area in order to maintain a uniform brightness over the entire surface including illumination regions spaced away from the light source to be illuminated by the reflected lights equivalent to the brightness over the illumination area which confronts the light source and is exposed to direct light.

However, the facetted reflective surface increases in brightness due to combined reflected lights and decreases in brightness due to shortage of the reflected light amount, which results in contrast variations in illumination on the projection surface or the illumination surface. Further, it is not easy to fabricate the facetted reflective surface by considering the balance of brightness to be obtained on the illumination surface, and the non-uniformity of brightness appears partially on the facetted reflective surface, even if the fabrication is satisfactory.

### SUMMARY OF THE INVENTION

The present invention has been made to solve the above-mentioned problems.

Accordingly, an object of the present invention is to provide a backlight illuminator which is capable of obtaining a high uniformity of the brightness of an illumination area, even if it is fabricated to have a relatively small internal space ratio and a size as thin as possible.

The applicant has made extensive efforts to overcome the problems inherent in the illuminator. The illuminator of the present invention uses a facetted reflective surface in order to basically maintain the uniformity of brightness. In addition, convex reflective surface (corresponding to a convex reflective surface curved and protruded) outward protruded or a concave reflective surface (corresponding to a concave reflective surface curved and recessed) inward recessed is formed to on at least a portion of the facetted reflective surface. The convex reflective surface or the concave reflective surface deflects its reflected light toward the light source so that the light is reversely returned as a reflected light for brightness reinforcement.

The light amount is adjusted by incrementally adding the light reflected back to the illumination surface illuminated by the direct light from the light source by means of the convex reflective surface or the concave reflective surface. Thus, a shortage of light amount partially occurring on the illumination surface can be compensated effectively and sufficiently. According to the present invention, the adjustment of the brightness on the illumination surface can be effected keeping a higher and stable uniformity of brightness all over the illumination surface.

In order to obtain the higher uniformity of brightness over the illuminated surface, the convex reflective surface or the concave reflective surface formed on at least a portion of the facetted reflective surface is effective.

According to an aspect of the present invention, a backlight illuminator comprises a plurality of light sources arranged at positions at predetermined intervals so as to confront each of the light an illumination surface to illuminate an adjacent predetermined illumination area of the illumination surface and reflectors arranged behind the rear surface of each light source and having a facetted reflective surface spread polygonally from the sides of each light source. The facetted reflective surface reflects illumination light on the rear surface side back to the illumination surface. The facetted reflective surface of the reflector has a convex reflective surface partially and outward protruded or a concave reflective surface partially and inward recessed to reflect and distribute the illumination light on the rear surface side back to an illumination area of the illumination surface between neighboring light sources or to an illumination area close to the light source.

The convex reflective surface of the reflector has a convex portion sized and shaped differently or the concave reflective surface of the reflector has a concave portion sized and shaped differently. Position and width for illumination at which light is reflected back to an allocated illumination region can be adjusted.

The convex reflective surface of the reflector has a convex portion shaped in a curved state or the concave reflective surface of the reflector has a concave portion shaped in a curved state.

The convex reflective surface or the concave reflective surface of the reflector is disposed at or near to a position spaced from the light source disposed above the facetted reflective surface.

The facetted reflective surface formed on both sides of each light source has a distant-projection reflective surface and a near-projection reflective surface. The distant-projection reflective surface reflects an illumination light back to an allocated illumination area of the illumination surface in the direction where the illumination light leaves from each light source. The near-projection reflective surface reflects an illumination light back to an allocated illumination area in the direction where the illumination light approaches the light source. The illumination area corresponding to the near-projection reflective surface is overlapped with the illumination area corresponding to the distant-projection reflective surface. The convex reflective surface or concave reflective surface acts as a near-projection reflective surface or as a part thereof.

The reflectors are interconnected by convex intermediate reflective surfaces in a curved or inverted-V shaped form. The concave intermediate reflective surfaces protruding upward from ends of the facetted reflective surface are formed on the sides of each light source.

The facetted reflective surface and/or the convex intermediate reflective surface of each reflector is formed of a reflective material with an optical diffusibility which suppresses a decrease in an optical directivity of a foamed surface, coarse surface or painted surface.

This and other objects, features, and advantages of the present invention will become more apparent upon a reading of the following detailed description and drawings.

### BRIEF DESCRIPTION OF THE DRAWINGS

FIG. 1 is a cross-sectional view of a backlight illuminator according to the present invention;

FIG. 2 is a diagramatic view of a portion of the backlight illuminator having a curved protruded intermediate reflector according to a first embodiment of the present invention illustrating how a facetted reflective surface including a convex reflective surface reflects light back to an illumination surface;

FIG. 3 is an enlarged diagramatic view of the facetted reflective surface and the convex reflective surface shown in FIG. 2;

FIG. 4 is a diagramatic view of a portion of the backlight illuminator having a curved protruded intermediate reflector according to a second embodiment of the present invention illustrating how a facetted reflective surface including a concave reflective surface reflects light back to an illumination surface;

FIG. 5 is an enlarged diagramatic view of the facetted reflective surface and the concave reflective surface shown in FIG. 4;

FIG. 6 is a diagramatic view of a portion of the backlight illuminator having a curved protruded intermediate reflector according to a third embodiment of the present invention illustrating how a facetted reflective surface including a convex reflective surface reflects light back to an illumination surface, wherein the convex reflective surface is formed at a position different from that of the first embodiment;

FIG. 7 is an enlarged diagramatic view of the facetted reflective surface and the convex reflective surface shown in FIG. 6;

FIG. 8 is a diagramatic view of a portion of the backlight illuminator having an inverted V-shaped protruded intermediate reflector according to a fourth embodiment of the present invention illustrating how a facetted reflective surface including a convex reflective surface reflects light back to an illumination surface;

FIG. 9 is an enlarged diagramatic view of the facetted reflective surface and the convex reflective surface shown in FIG. 8;

FIG. 10 is a diagramatic view of a portion of the backlight illuminator having a curved protruded intermediate reflector and a concave reflective surface according to a fifth embodiment of the present invention illustrating how a facetted reflective surface including a concave reflective surface reflects light back to an illumination surface; and

FIG. 11 is an enlarged diagramatic view of the facetted reflective surface and the concave reflective surface shown in FIG. 10 according to the fifth embodiment of the present invention.

### DETAILED DESCRIPTION OF THE INVENTION

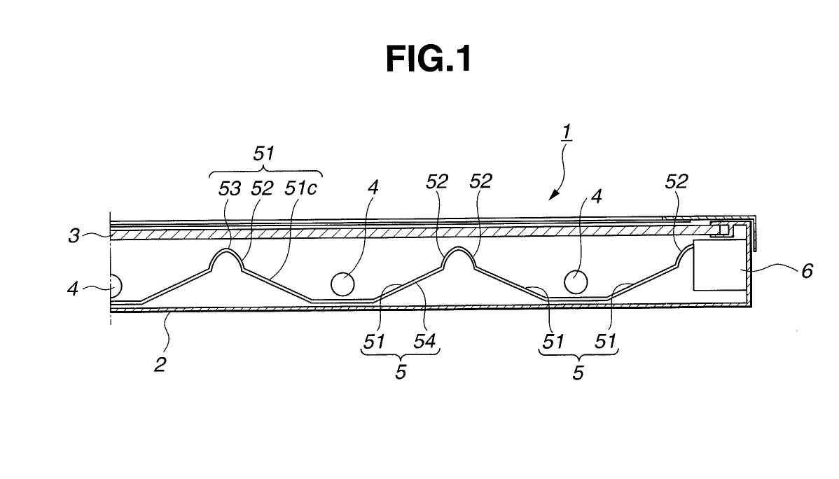

A backlight illuminator according to embodiments of the present invention will be described below in detail by referring to FIGS. 1 to 11.

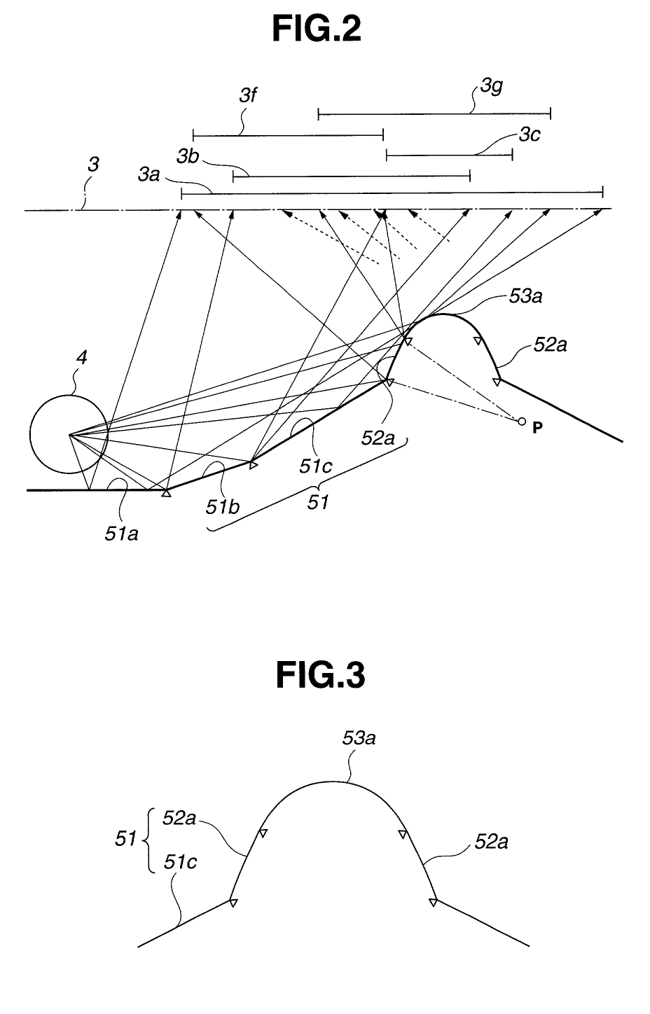

In FIGS. 2 to 11, angled nodes in a reflector are shown by the symbol Δ.

In FIG. 1, numeral 1 represents a backlight illuminator to which plural light sources are applied acting as backlighting for a liquid crystal display. Numeral 2 represents a box acting as an illumination cabinet. Numeral 3 represents an illumination plate disposed on the front (top) surface of the box 2. The illumination surface is formed of, for example, a semi-opaque plate for light diffusion. Numeral 4 represents light sources each disposed on the lower side confronting the illumination surface 3 and at predetermined intervals within the box 2. The light source 4 is a linear light source such as a cold cathode fluorescent tube. Numeral 5 represents a series of reflectors disposed at the rear (lower) side of the light source 4. Each reflector 5 reflects the illumination light propagating downward or sideward from the light source 4 back to the illumination surface 3. Numeral 6 represents an inverter built in the end of the box 2 to control the lighting of the each light source 4.

In FIG. 1, the illuminator 1 includes plural light sources placed at the lower side confronting the illumination surface 3 and arranged at predetermined intervals and reflectors each for reflecting an illumination light directed downward and sideward from the light source 4 back to the illumination surface 3. Each of the plural light sources 4 illuminates a predetermined illumination region of the illumination surface 3 upwardly. Each reflector has a facetted reflective surface 51 polygonally spread out from both sides of each light 4.

The facetted reflective surface 51 of the reflector 5 has a horizontal reflective surface confronting the illumination surface 3, a flat reflective surface angled and is continuous to the horizontal reflective surface or a concave reflective surface curved inward gradually from the end of the horizontal reflective surface and a protruded intermediate reflective surface continuous to the flat or concave reflective surfaces and protruded in the shape of an arc or an inverted letter V.

The protruded intermediate reflective surface includes a convex portion protruded partially outward or a concave portion recessed inward. The illumination surface has a region illuminated by the convex reflective surface or the concave reflective surface. The convex reflective surface reflects the light back to an upper illumination region adjacent to a region between neighboring light sources 4. The concave reflective surface reflects the light back to an illumination region closer to the light source than the upper illumination region. In this case, the ends of the facetted reflective surfaces 51 are configured to be continuous to each other at the intermediate portion between adjacent light sources 4. The intermediate portion is protruded in the shape of an arc or an inverted letter V.

The facetted reflective surface 51 of the reflector 5 is formed of an optical reflective material, such as, for example, a formed surface, coarse surface or painted surface. The optical reflective material suppresses a decrease in the optical directivity and provides an optical diffusibility. In an embodiment of the present invention, a thermoplastic resin such as polyethylene phthalate resin or polyester resin is used for the facetted reflective surface. The thermoplastic resin is foamed, for example, at a relative low expansion ratio to form a white foamed sheet. The white foamed sheet is formed in a desired shape as it is. If necessary, the white foamed sheet is integrally bonded with an adhesive agent on the surface of a reinforced plate 54 as shown in FIG. 1. The reinforced plate 54 has the same shape as that of the white foamed sheet and is formed of a thin metal plate, such as, aluminum or iron or a composite resin plate.

The expansion ration of thermoplastic resin for forming the facetted reflective surface 51 is 10 times or less or up to 5 times. The cell diameter is set to, for example, 10 μm or less. Then, the white foamed sheet made of, for example, polyethylene phthalate resin having excellent optical diffusibility and high temperature resistance (e.g. about 240° C.) suitable for use in the facetted reflective surface 51 is obtained. The white foamed sheet is molded in a desired shape while it is heated. In this case, the facetted reflective surface 51 exhibits such optical characteristics that the reflected light diffusion range is about 20°, and the total reflective ratio is 99% and the diffusion reflective ratio is 96%.

The facetted reflective surface 51 is disposed behind or on the lower side of each light source 4. The facetted reflective surface 51 has three or more surfaces including a flat surface, an angled surface, and an arc surface, symmetrically disposed on both sides of the light source 4. The light reflected from each reflective surface compensates the brightness decreased in inverse proportional to the square of the distance in the direction leaving from each light source 4 with reference to the brightness of the direct light of the illumination surface 3 at the position above each light source 4. The angle of each reflective surface to the light source 4 and the reflective direction according to the angle are suitably set in order to obtain uniformed brightness. Thus, reflected lights are respectively allocated to predetermined illumination regions of the illumination surface 3.

A first embodiment of the present invention will be explained with reference to FIGS. 2 and 3.

In the first embodiment, the facetted reflective surface 51 of the reflector 5 disposed on both sides of each light source 4 has a horizontal reflective surface 51a, first and second flat reflective surfaces 51b and 51c, and an protruded intermediate reflective surface 53a with a convex reflective surface 52a as shown in FIGS. 2 and 3. The horizontal reflective surface 51a is spaced downward from the light source 4 and is extended horizontally. The first and second reflective surfaces 51b and 51c are continuous to the horizontal reflective surface 51a and are gradually bent upward in a stepwise fusion at a predetermined angle. The convex reflective surface 52a protrudes at a predetermined arc angle outward from the junction of the flat reflective surface 51C. The protruded intermediate reflective surface 53a is provided with an arc surface and is located at the intermediate position between neighboring light sources 4 protruding upward from the junctions of the flat reflective surface 51C.

In the embodiment shown in FIG. 2, three reflective surfaces 51b, 51c and 52a and the protruded intermediate reflective surface 53a which are continuous to the horizontal reflective surface 51a are formed on either side of each light source 4.

The facetted reflective surface 51 disposed on both sides of the light source 4 is provided with the reflective surfaces 51a, 51b and 51c which reflect the light back to the illumination surface 3 in the direction where the light leaves from the light source 4, and the reflective surface 52a which reflects the light back in the direction where the light approaches the light source 4. Thus, the illumination regions 3a-3c where it is illuminated by the light reflected back to the light source 4 is overlapped with the illumination regions 3a-3c where the light leaves from the light source. In FIG. 2, the trajectories of the lights reflected back to allocated illumination regions are shown by arrows.

The horizontal reflective surface 51a is assigned to project the reflected light to a broader illumination region 3a extending from the adjacent surface above the light source 4, the convex intermediate reflective surface 53, to a surface above the neighboring light source.

The first flat reflective surface 51b is assigned to project the reflected light to the illumination region 3b extending from the region spaced slightly away from the light source 4 to an adjacent region of the convex intermediate reflective surface 53.

The second flat reflective surface 51c is assigned to project the reflected light to the illumination region 3c extending from the inner position of the convex intermediate reflective surface 53 to the outer position of the convex intermediate reflective surface 53. The convex intermediate reflective surface 53a on either side of the light source 4 reflects the light back to an illumination region 3g located above between two neighboring light sources 4.

The convex reflective surface 52a is a portion of the protruded intermediate reflective surface 53a spaced away from the light source 4, and is elevated toward the illumination surface 3 higher than the light source 4. The convex reflective surface 52a is formed in the shape of an arced rib or belt with a relatively narrow width. The arc of the convex reflective surface is relatively small by making relatively large the curvature radius from the center point P of the arc surface. The convex reflective surface 52a is assigned to project the reflected light of the light source 4 to the illumination region including the illumination region 3a to which the horizontal reflective surface 51a projects the reflected light, the illumination region 3b to which the first flat reflective surface 51b projects the reflected light and the illumination region 3c to which the second flat reflective surface 51c projects the reflected light partially or wholly overlapping each other. The convex reflective surface 52a is assigned to project the reflected light back to a relatively broader illumination region 3f ranging from a region above the light source 4 to a region close to the protruded intermediate reflective surface 53a. The dimension of the arc surface of the convex reflective surface 52a, for example, the effective width, the radius of the arc surface, and the like are variable so that the brightness can be controlled to a predetermined level by adjusting the illumination area and width.

In summary, the brightness of the illumination surface 3 is subjected to uniform primarily by reflective surfaces 51a, 51b, 51c, and 53a. The reflective surface 52a compensates insufficient light amount in the non-uniform brightness region. Thus, the substantial uniform brightness of the illumination surface 3 can be obtained.

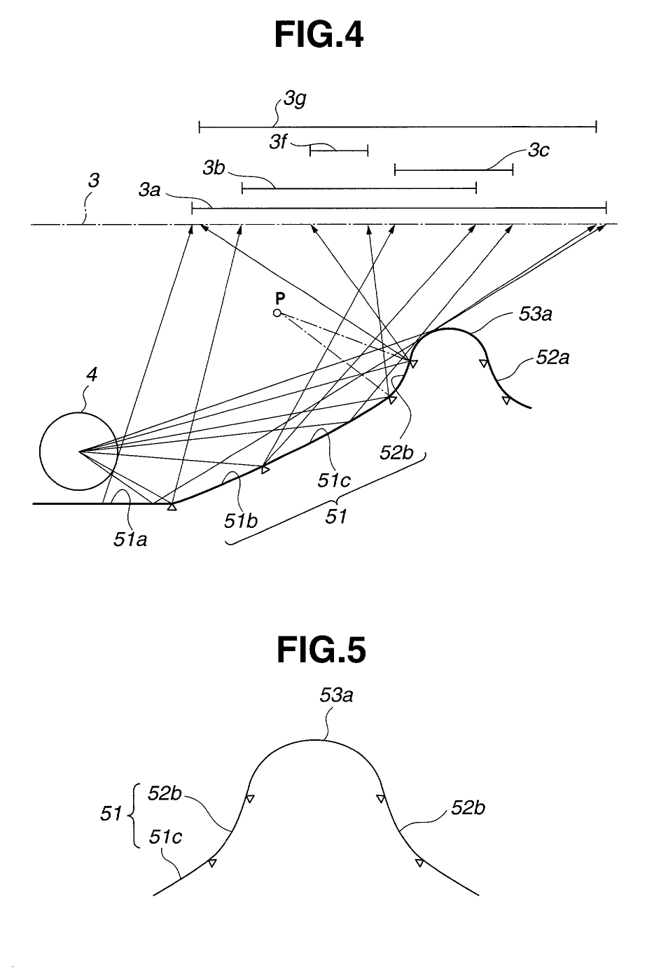

FIGS. 4 and 5 show a second embodiment of the present invention.

The illuminator according to the second embodiment of the present invention differs from the first embodiment in that the reflector 5 is provided with a concave reflective surface 52b recessed at a predetermined arc in place of the convex reflective surface 52a of the first embodiment. According to the second embodiment, the facetted reflective surface 51 has three surfaces including the reflective surfaces 51b, 51c, and 52b and the reflective surface 53a connected to the horizontal reflective surface 51a on both sides of the light source 4.

The facetted reflective surface 51 formed on both sides of the light source 4 has the reflective surfaces 51a, 51b, and 51c, and the reflective surface 52b. The reflective surfaces 51a, 51b and 51c respectively reflect the lights back to illumination regions of the illumination surface 3 in the direction where the reflected light leaves from the light source 4. The reflective surface 52b directs the reflected light in the direction where the reflected light returns toward the light source 4. Meanwhile, the illumination region in the direction where the light returns toward the light source 4 is overlapped with the illumination region in the direction where the light leaves from the light source 4.

In the second embodiment, the trajectories of lights reflected to respective illumination regions are shown by arrows in FIG. 4.

Similar to the first embodiment, the horizontal reflective surface 51a and the first and second flat reflective surfaces 51b and 51c project the reflected lights onto the corresponding illumination areas 3a, 3b and 3c, respectively. The protruded intermediate reflective surface 53a reflects the reflected light back to the illumination area 3g which is as broad as the illumination region 3a.

As to the concave reflective surface 52b, the curvature radius from the center point P of the arc is relatively large so that the depth of the arc is relatively shallow. The concave reflective surface 52b is assigned to project the reflected light onto the illumination region including the illumination region 3a to which the horizontal reflective surface 51a projects the reflected light, the illumination area 3b to which the first flat reflective surface 51b projects the reflected light, and the illumination area 3c to which the second flat reflective surface 51c projects the reflected light partially and wholly overlapping each other. In this embodiment, the concave reflective surface 52b projects the reflected light onto a relatively narrow illumination region 3f between the light source 4 and the protruded intermediate reflective surface 53a. Similarly, the brightness can be controlled to a desired level by adjusting the size and shape of the concave arc surface. Thus, the substantially uniform brightness of the illumination surface 3 can be obtained.

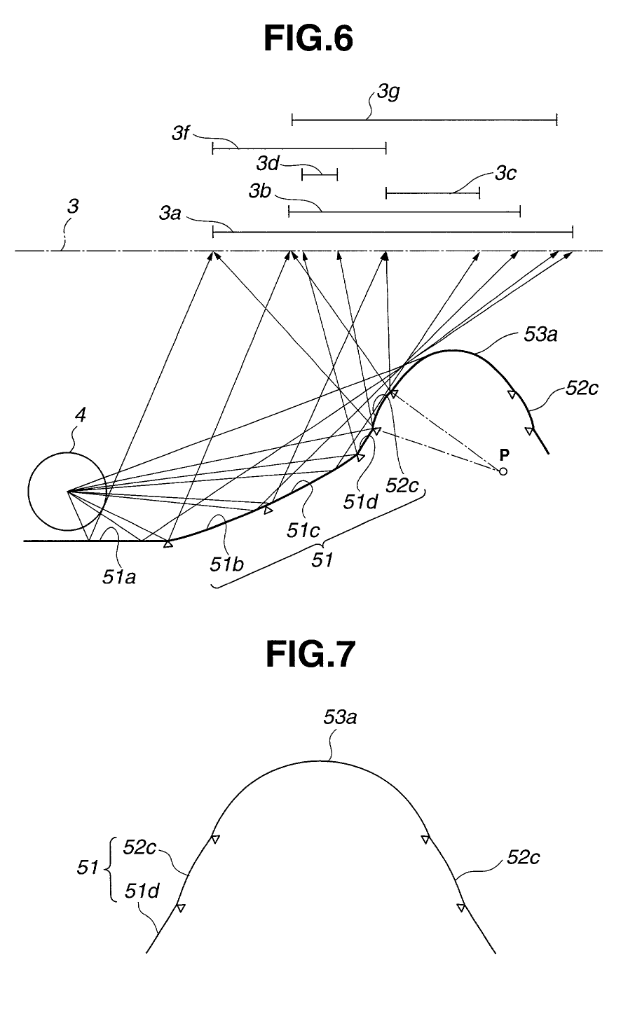

A third embodiment of the present invention will be explained with reference to FIGS. 6 and 7.

The illuminator according to the third embodiment of the present invention differs from the first embodiment in that the reflector 5 is provided with a convex reflective surface 52c which is narrower than that of the convex reflective surface 52a in place of the convex reflective surface 52a of the first embodiment. According to the third embodiment, the facetted reflective surface 51 has four surfaces including reflective surfaces 51b, 51c, 51d and 52c and the reflective surface 53a connected to the horizontal reflective surface 51a on both sides of the light source 4.

The reflective surfaces 51a, 51b and 51c reflect the light back to the illumination surface 3 in the direction where the light leaves from the light source 4. The reflective surfaces 51d and 52b reflect the light back to the illumination surface 3 in the direction where the light approaches the light source 4 overlapping with the illumination area where the light leaves from the light source.

In the third embodiment, the trajectories of lights reflected to respective illumination regions are shown by arrows in FIG. 6.

Similar to the first embodiment, the horizontal reflective surface 51a and the first to second flat reflective surfaces 51b and 51c reflect lights back to the illumination area 3a, 3b and 3c, respectively. The protruded intermediate reflective surface 53a reflects the light back to the illumination area 3g.

In the third embodiment, the third flat reflective surface 51d reflects the light back to the illumination region including the illumination section 3a to which the horizontal reflective surface 51a projects the reflected light and the illumination sections 3b to which the horizontal reflective surface 51b projects the reflected light partially or wholly overlapping each other. In this example, the third flat reflective surface 51d reflects the light back to the relatively narrow illumination section 3d close to the protruded intermediate reflective surface 53a. The convex reflective surface 52c reflects the light back to the illumination regions where the illumination area 3a to which the horizontal reflective surface 51a projects the reflected light, the illumination section 3b to which the first flat reflective surface 51b projects the reflected light and the illumination area 3d to which the first flat reflective surface 51d projects the reflected light partially or wholly overlapping each other. In this example, the convex reflective surface 52c reflects the light back to the illumination area 3f between the light source 4 and the protruded intermediate reflective surface 53a. The size and shape of the convex reflective surface 52c can be variable so that the brightness can be adjusted to a desired level. Thus, the substantially uniform brightness of the illumination surface 3 can be obtained.

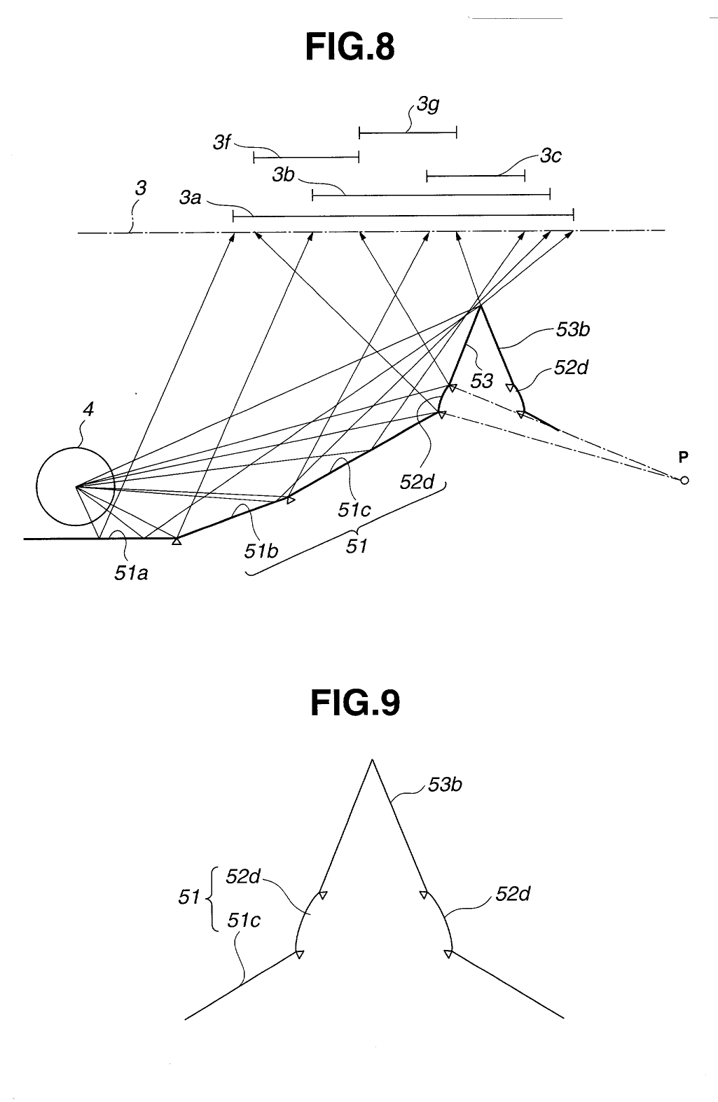

A fourth embodiment of the present invention will be explained with reference to FIGS. 8 and 9.

The illuminator according to the fourth embodiment of the present invention differs from the first embodiment in that the reflector 5 is provided with an inverted-V shaped protruded intermediate reflective surface 53b instead of the protruded intermediate reflective surface 53a having a convex reflective surface 52d of narrower width in the protruded intermediate reflective surface 53b. The facetted reflective surface 51 has three surfaces including the reflective surfaces 51b, 51c and 52d and the reflective surface 53b connected to the horizontal reflective surface 51a on both sides of the light source 4.

The reflective surfaces 51a, 51b and 51c reflect the light back to the illumination surface 3 in the direction where the light leaves from the light source 4. The reflective surfaces 52d and 53b reflect the light back to the illumination surface 3 in the direction where the light approaches the light source 4. The illumination region in the direction where the light approaches the light source and the illumination region in the direction where the light leaves from the light source are overlapped each other.

The trajectories of lights reflected to respective illumination areas are shown by arrows in FIG. 8.

Similar to the first embodiment, the horizontal reflective surface 51a and the first to second flat reflective surfaces 51b and 51c reflect lights back to illumination areas 3a, 3b and 3c, respectively. The protruded intermediate reflective surface 53b reflects the light back to a relatively narrow illumination area 3g.

In the fourth embodiment, the convex reflective surface 52d reflects the light of the light source 4 back to the illumination region including the illumination area 3a to which the horizontal reflective surface 51a projects the reflected light and the illumination regions 3b to which the horizontal reflective surface 51b projects the reflected light partially or wholly overlapping each other. In this embodiment, the convex reflective surface 52d reflects the light back to the relatively narrow illumination area 3f between the light source 4 and the protruded intermediate reflective surface 53b. The size and shape of the convex reflective surface 52d is variable so that the brightness can be adjusted to a desired level. Thus, the substantially uniform brightness of the illumination surface 3 can be obtained.

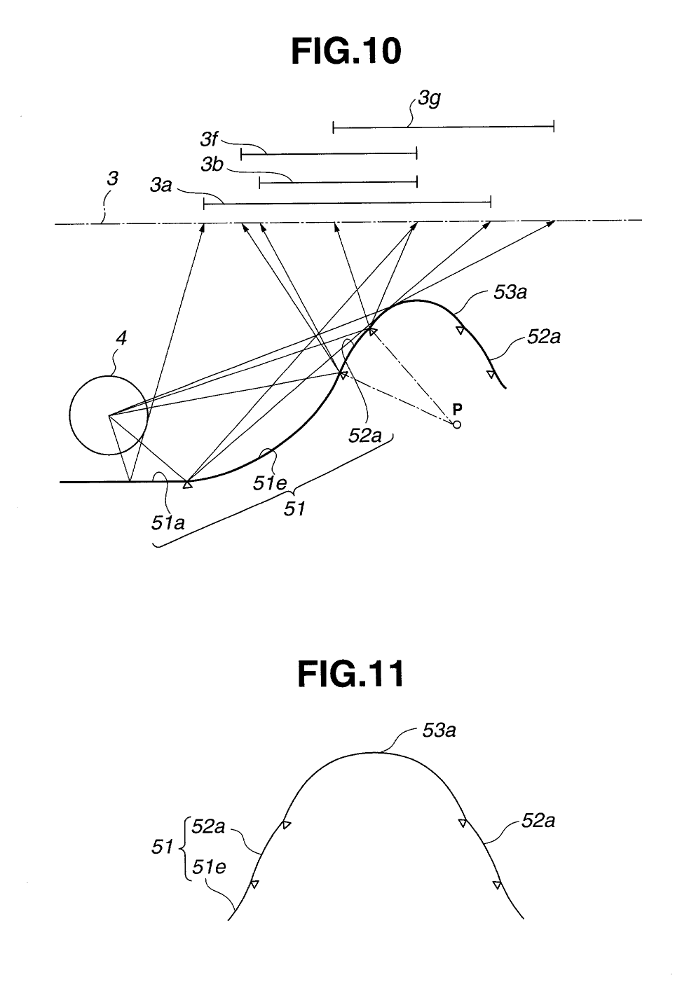

A fifth embodiment of the present invention will be explained with reference to FIGS. 10 and 11.

The illuminator according to the fifth embodiment of the present invention differs from the first embodiment in that the reflector 5 is provided with a concave reflective surface 51e, a protruded intermediate reflective surface 53a, and a convex reflective surface 52a in place of the horizontal reflective surface 51a and the flat reflective surfaces 51b and 51c. The facetted reflective surface 51 has three surfaces including the reflective surfaces 51b, 51e and 52a and the reflective surface 53a connected to the flat reflective surface 51a on both sides of the light source 4.

The reflective surface 51a reflects the light back to the illumination surface 3 in the direction where the light leaves from the light source 4. The reflective surfaces 51e and 52a reflect lights back to the illumination surface 3 in the direction where the light approaches the light source 4. The illumination region in the direction where the light leaves from the light source and the illumination region in the direction the light approaches the light source 4 are overlapped each other.

The trajectories of lights reflected to respective illumination areas are shown by arrows in FIG. 10.

Similar to the first embodiment, the horizontal reflective surface 51a and the concave reflective surface 51e reflect lights back to illumination areas 3a and 3b, respectively. The protruded intermediate reflective surface 53a reflects the light back to the illumination area 3g.

In the fifth embodiment, the convex reflective surface 52a reflects the light of the light source 4 back to the illumination region including the illumination area 3a to which the horizontal reflective surface 51a projects the reflected light and the illumination area 3b to which the concave reflective surface 51e projects the reflected light partially and wholly overlapping each other. In this embodiment, the convex reflective surface 52a reflects the light back to the illumination region 3f covering from the surface close to the light source 4 to the protruded intermediate reflective surface 53a. The size and shape of the convex reflective surface 52a is variable so that the brightness of the illumination surface 3 can be adjusted to a desired level.

According to the backlight illuminator 1 of the present invention, the brightness of the illumination surface 3 is subjected to substantially uniform by providing the facetted reflective surface 51 with the horizontal reflective surface, the angled or curved reflective surface, and the protruded intermediate reflective surface 53. The convex reflective surface 52a or the concave reflective surface 52b deflects the light toward the light source 4 or toward the illumination surface 3 so as to reflect it back to the illumination region 3f of the illumination surface 3. Thus, the reflector 5 can compensate a shortage of brightness with the reflected light in case where the illumination surface 3 provides an uniformed brightness but partially lacks a sufficient brightness.

The present invention is applicable to a backlight for slim illuminators which require a high brightness and a high uniformity, for example, a backlight for liquid crystal displays having the internal space ratio of less than 50% with respect to the lamp pitch and the thickness of 20 mm or less. In other words, the backlight illuminator according to the present invention is applicable to displays or signs for which the conventional backlight can not be applicable, because the illumination surface is inferior in uniform brightness although it has sufficient brightness.

According to the present invention, the convex reflective surface or the concave reflective surface should not be limited to an arc but may be an oval convex or an oval concave, or a combination thereof. There is no limitation in the number of curved surfaces. Further, the convex or concave arc reflective surface may be a protruded or recessed facetted surface. The horizontal reflective surface is not necessarily provided.

A single convex reflective surface or concave reflective surface applied to the facetted reflective surface satisfactorily achieves a predetermined brightness adjusting function. However, if necessary, the convex reflective surface or the concave reflective surface or both may be disposed at plural locations on the facetted reflective surface. The convex reflective surface or concave reflective surface may be disposed at an intermediate region of the facetted reflective surface, or a region close to the light source.

The facetted reflective surface and the protruded intermediate reflective surface of the reflector may be an optical diffusion surface such as coarse surface or painted surface prepared by satin or paint finishing in place of the foamed resin surface. If the reflective surface is formed of a thin film such as a foamed film or a metal foil, the film is required to be reinforced by a backing base member. In this case, the base member integrated with the thin film may be prepared, and then, it is subjected to bent in a predetermined shape to form the reflective surface.

Obviously, many modifications and variations of the present invention are possible in the light of the above teachings. It is therefore to be understood that within the scope of the appended claims, the invention may be practiced otherwise than as specifically described.

What is claimed is:

1. A backlight illuminator comprising:
a plurality of light sources arranged at predetermined intervals, each of said light sources confronting an illumination surface, each of said light sources illuminating a predetermined illumination area of said illumination surface; and
a reflector arranged behind the rear surface of each light source and having a facetted reflective surface spread polygonally from both sides of each light source, said facetted reflective surface reflecting illumination light on the rear surface of said light source back to said illumination surface;
wherein said facetted reflective surface of said reflector includes a convex reflective surface partially and outward protruded or a concave reflective surface partially and inward recessed to reflect the illumination light on the rear surface of said light source back to an illumination area of said illumination surface between two neighboring light sources or to an illumination area close to said light source.

2. The backlight illuminator as defined in claim 1, wherein said convex reflective surface of said reflector includes a convex portion subjected said size and shape to be variant or said concave reflective surface of said reflector includes a concave portion subjected said size and shape to be variant, whereby position and width for illumination at which light is reflected back to an allocated illumination region can be adjusted.

3. The backlight-type illuminator as defined in claim 2, wherein said convex reflective surface of said reflector includes an outwardly curved convex portion or said concave reflective surface of said reflector includes an inwardly curved concave portion.

4. The backlight illuminator as defined in claim 1, wherein said convex reflective surface or said concave reflective surface of said reflector is disposed at a furthermost position spaced from said light source.

5. The backlight illuminator as defined in claim 1, wherein said facetted reflective surface spread on both sides of said light source includes a first projection reflective surface and a second projection reflective surface; said first projection reflective surface reflecting illumination light back to an illumination area of said illumination surface in the direction where the illumination light leaves from said light source; said second projection reflective surface reflecting illumination light back to an illumination area in the direction where the illumination light approaches said light source, said illumination area to which said second projection reflective surface projects the reflected light being overlapped with the illumination area to which said first projection reflective surface; and said convex reflective surface or concave reflective surface acting as a second projection reflective surface or as a part thereof.

6. The backlight illuminator as defined in claim 1, wherein said reflectors includes outwardly curved or inverted V-shaped convex intermediate reflective surfaces, said concave intermediate reflective surfaces protruding upward from ends of said facetted reflective surface spread on both sides of each light source.

7. The backlight illuminator as defined in claim 1, wherein said reflector is formed of a reflective material having an optical diffusibility.

8. The backlight illuminator as defined in claim 7, wherein said reflector is formed of the reflective material having a formed surface.

9. The backlight illuminator as defined in claim 7, wherein said reflector is formed of the reflective material having a coarse surface.

10. The backlight illuminator as defined in claim 7, wherein said reflector is formed of the reflective material having a painted surface.
